(19) United States
(12) Patent Application Publication
(10) Pub. No.: US 2020/0185758 A1
(43) Pub. Date: Jun. 11, 2020

(54) HYBRID LIQUID-SOLID ELECTROLYTE FOR A LITHIUM METAL BATTERY

(71) Applicant: The Board of Trustees of the University of Illinois, Urbana, IL (US)

(72) Inventors: Andrew A. Gewirth, Urbana, IL (US); Maria A. Philip, Champaign, IL (US)

(21) Appl. No.: 16/702,759

(22) Filed: Dec. 4, 2019

Related U.S. Application Data
(60) Provisional application No. 62/777,431, filed on Dec. 10, 2018.

(51) Int. Cl. H01M 10/056; H01M 10/0525; H01M 4/38; H01M 4/133

(52) U.S. Cl. CPC H01M 10/056; H01M 10/0525; H01M 2300/0034; H01M 4/133; H01M 4/382

(57) ABSTRACT

A hybrid liquid-solid electrolyte for a lithium metal battery includes a solid-phase material comprising a lithium thiophosphate; a solvate comprising a lithium salt and a first solvent; and a second solvent comprising a fluorinated ether to reduce viscosity of the solvate. A method of making a hybrid liquid-solid electrolyte comprises assembling together: (a) a solid-phase material comprising a lithium thiophosphate; (b) a solvate comprising a lithium salt and a first solvent; and (c) second solvent for reducing a viscosity of the solvate, where the second solvent comprises a fluorinated ether.

### RELATED APPLICATION

The present patent document claims the benefit of priority under 35 U.S.C. § 119(e) to U.S. Provisional Patent Application No. 62/777,431, which was filed on Dec. 10, 2018, and is hereby incorporated by reference in its entirety.

### FEDERALLY SPONSORED RESEARCH OR DEVELOPMENT

This invention was made with government support under DE-AC02-06CH11357 awarded by the Department of Energy. The government has certain rights in the invention.

### TECHNICAL FIELD

The present disclosure is related generally to battery technology and more particularly to a hybrid electrolyte formulation for lithium metal batteries.

### BACKGROUND

Lithium ion batteries (LIBs) have become crucial to the automotive industry with the commercialization of electric vehicles and to the technology sector with the increase in portable electronics. Despite substantial increases in production, LIBs may soon be unable to meet rising market demands since the practical energy density of LIBs is nearing the theoretical value set by the constituent anode and cathode materials. Lithium metal batteries (LMBs), which have lithium metal electrodes, are considered more favorable in this regard due to their high theoretical specific capacity of 3860 mAh g⁻¹ compared to 372 mAh g⁻¹ for a graphite anode.

Challenges include the fire and explosion hazard posed by commercial liquid electrolytes (LEs) in lithium metal batteries due to the thermodynamic instability of carbonate solvents against lithium metal electrodes. Additionally, lithium metal anodes may form dendrites that can lead to a short circuit, which, if left unchecked, can increase the internal cell temperature beyond safe operating conditions. Solid electrolytes (SEs) have been identified as a safer alternative when used with Li metal anodes. However, SEs are less mechanically stable than LEs when the battery is cycled, and SEs may be inherently thermodynamically unstable against lithium metal anodes.

### BRIEF SUMMARY

A hybrid liquid-solid electrolyte for a lithium metal battery includes a solid-phase material comprising a lithium thiophosphate; a solvate comprising a lithium salt and a first solvent; and a second solvent comprising a fluorinated ether to reduce viscosity of the solvate.

A method of making a hybrid liquid-solid electrolyte comprises assembling together: (a) a solid-phase material comprising a lithium thiophosphate; (b) a solvate comprising a lithium salt and a first solvent; and (c) second solvent for reducing a viscosity of the solvate, where the second solvent comprises a fluorinated ether.

### BRIEF DESCRIPTION OF THE DRAWINGS

FIGS. 1A and 1B show exemplary electrochemical impedance spectroscopy (EIS) data fits for (FIG. 1A) Li/LPS/Li and (FIG. 1B) Li/LGPS/Li. The experimental data is represented by circles and the data fits are shown by dashed lines. FIGS. 1C-1D show cell impedance over 48 h after contacting (FIG. 1C) LPS and (FIG. 1D) LGPS with Li electrodes in a Li—Li symmetric cell. Rₑₗ, R_{cell}, and CPE_{dl} represent bulk electrolyte resistance, cell resistance, and double layer capacity (constant phase element).

FIG. 1E shows an exemplary battery cell including an anode, a cathode, and a hybrid liquid-solid electrolyte sandwiched between the anode and cathode.

FIGS. 2A and 2B show exemplary EIS data fits for (FIG. 2A) Li/solvate/LPS/solvate/Li and (FIG. 2B) Li/solvate/LGPS/solvate/Li. The empirical data is represented by circles and the data fits are shown by dashed lines. FIGS. 2C and 2D show cell impedance over 48 h after contacting the (FIG. 2C) solvate/LPS/solvate and (FIG. 2D) solvate/LGPS/solvate with Li electrodes in a Li—Li symmetric cell.

FIGS. 3A and 3B show cell resistance values versus time of contact (0-47 h) between electrode and electrolyte. Values were extracted from FIGS. 1C-1D and FIGS. 2C-2D for (FIG. 3A) LPS and (FIG. 3B) LGPS cells.

FIGS. 4A-4C show cross-sectional SEM images of (FIG. 4A) LPS-solvate, (FIG. 4B) LGPS-solvate nearer the surface, and (FIG. 4C) LGPS-solvate farther from the surface. All samples were analyzed after 48 h contact with Li metal electrodes. Boxed regions in the figure are used for EDX analysis.

FIGS. 5A-5D show cyclic voltammetry of (FIG. 5A) Li/LPS/Li, (FIG. 5B) Li/LGPS/Li, (FIG. 5C) Li/solvate/LPS/solvate/Li, and (FIG. 5D) Li/solvate/LGPS/solvate/Li. Inset in (FIG. 5A) is for cycle 3 of Li/LPS/Li. Inset in (FIG. 5C) is zoomed in.

FIG. 6 shows peak current density as a function of the square root of the scan rate for the Li/solvate/LGPS/solvate/Li cell. For the anodic (positive) plot, slope=21.61±1.93 mA s^{1/2} cm⁻² V^{-1/2}, y-intercept=6.27421×10⁻⁴±3.61736×10⁻² mA cm⁻², and R²=0.97675. For the cathodic (negative) plot, slope=−16.12±1.59 mA s^{1/2} cm⁻² V^{-1/2}, y-intercept=−3.2572×10⁻²±2.13686×10⁻² mA cm⁻², and R²=0.97154.

FIGS. 7A-7D show exemplary EIS data fits for (FIG. 7A) Li/LPS/Li, (FIG. 7B) Li/LGPS/Li, (FIG. 7C) Li/solvate/LPS/solvate/Li, and (FIG. 7D) Li/solvate/LGPS/solvate/Li highlighting the compressed semicircle resulting from the CPE element (an imperfect capacitor). The experimental data is represented by circles and the data fits are shown by dashed lines.

FIGS. 8A-8D show cross-sectional EDX spectra corresponding to FIGS. 4A-4C and Table 3 for (FIG. 8A) LPS-solvate region 1, (FIG. 8B) LPS-solvate region 2, (FIG. 8C) LGPS-solvate region 3, and (FIG. 8D) LGPS-solvate region 4.

FIG. 9 shows powder XRD diffractograms of LPS (top) and LGPS (bottom). Vertical lines represent positions based on powder diffraction file (PDF) 04-014-8383 for LPS and 04-017-8585 for LGPS.

FIG. 10 shows cyclic voltammetry of a Li—Li symmetric cell with solvate and a Whatman glass fiber separator (1823-125) with a thickness of 0.67 mm and a pore size of 2.7 μm.

FIGS. 11A-11C show electrochemical performance data for a hybrid Li₂S battery, where FIG. 11A shows the charge and discharge profile of the hybrid cell; FIG. 11B shows the corresponding differential capacity plot; and FIG. 11C shows the cycling performance of the hybrid Li₂S cell using a solvSEM electrolyte.

### DETAILED DESCRIPTION

A hybrid liquid-solid electrolyte for a lithium metal battery has been developed to overcome the shortcomings of existing solid electrolytes. The hybrid liquid-solid electrolyte combines solid-phase lithium thiophosphates, which may exhibit ionic conductivities at room temperature comparable to those of commercial ionic liquids, with highly concentrated “solvent-in-salt” solvates. The new hybrid technology may simplify and improve the processability of electrolytes for lithium metal battery cells and increase the mechanical stability of the electrolyte. Further benefits may include reduced cell resistance and a lower overall cost of the battery cells.

The inventive hybrid liquid-solid electrolyte includes (a) a solid-phase material comprising a lithium thiophosphate; (b) a solvate comprising a lithium salt and a first solvent; and (c) a second solvent comprising a fluorinated ether, where the second solvent is used to reduce the viscosity of the solvate, thereby ensuring the desired processability and performance of the electrolyte.

The solvate is understood to be a highly concentrated ionic liquid that may be very viscous. For example, the solvate may include the lithium salt at a molar concentration of about 1-5 moles of salt per liter of solvent, depending on the lithium salt and solvent. Suitable lithium salts may comprise lithium bis(trifluoromethane sulfonyl)imide (LiTFSI), lithium hexafluorophosphate (LiPF₆), lithium tetrafluoroborate (LiBF₄), and lithium bis(fluorosulfonyl)imide (LiFSI). The solvent (“first solvent”) employed to form the solvate may comprise 1,3-dioxolane (DOL), 1,2-dimethoxyethane (DME), ethylene carbonate, dimethyl carbonate, tetrahydrofuran, acetonitrile, triethylene glycol dimethyl ether, and/or water. Suitable molar concentrations for LiTFSI may be about 5 mol/L when used with DOL/DME, about 1-2 mol/L when used with acetonitrile, and about 1 mol/L when used with triethylene glycol methyl ether.

The fluorinated ether used to reduce the viscosity of the solvate may be a highly fluorinated ether (HFE). In other words, the fluorinated ether may be at least about 90% fluorinated, and in some cases at least about 95% fluorinated. Exemplary (highly) fluorinated ethers include 1,1,2,2,-tetrafluoroethyl ether and 2,2,3,3-tetrafluoropropyl ether.

The solid electrolyte part of the hybrid liquid-solid electrolyte is a solid-phase material comprising a lithium thiophosphate, such as Li₁₀GeP₂S₁₂ (LGPS) or Li₇P₃S₁₁ (LPS). Generally speaking, the lithium thiophosphate is a compound comprising the elements lithium, phosphorus and sulfur and which may further include an element selected from the group consisting of germanium, aluminum, tin, chlorine, bromine, boron, and silicon. Both LGPS and LPS have ionic conductivities at room temperature (σ_{LGPS,Li}_{⁺}=12 mS cm⁻¹ and σ_{LPS,Li}_{⁺}≈10⁻³ S cm⁻¹) comparable to commercial liquid electrolytes, such as 1 M LiPF₆ in a mixture of carbonate solvents (σ≈10⁻² S cm⁻¹). In addition to good conductivity, the lithium thiophosphates may have beneficial physical characteristics in comparison with other solid electrolytes. For example, both LGPS and LPS powders do not require high-temperature sintering procedures to obtain high densification when prepared as pellets. Additionally, lithium thiophosphates have low Young's moduli which means the compounds can elastically deform to maintain contact with lithium metal electrodes while cycling, thereby promoting mechanical stability.

The solid-phase material comprising the lithium triophosphate may take the form of a particulate material (a powder) or a porous body.

In the former case, which may be referred to as the “powder embodiment,” the particulate material or powder may be mixed with the solvate and the second solvent. Thus, the hybrid liquid-solid electrolyte may have a paste-like, spreadable rheology that facilitates application of the hybrid electrolyte to an electrode for use in a battery cell.

In the latter case, which may be referred to as the “porous body embodiment,” the porous body may include interconnected pores that are penetrated by the solvate and the second solvent. Such a porous body may be formed by compacting powders into a pellet or other desired geometry in a pressing process typically carried out at room temperature (e.g., 20-25° C.). The porous body may be said to include open pores or open porosity, which facilitates penetration by the solvate and second solvent, and the porous body may or may not include some fraction of closed pores in addition to the open pores. In this latter example, the hybrid liquid-solid electrolyte may comprise a more rigid structure that may make the process of battery cell assembly more challenging.

Both the powder and the porous body embodiments are examples of what may be described as SolvSEM technology, which utilizes a solvate-solid electrolyte mixture or composite in place of a “bare” solid electrolyte (with no solvate). Advantages of the SolvSEM technology for battery cell applications compared to bare solid electrolyte technology may include improved mechanical stability (e.g., reduced cracking), a reduction of grain boundary resistance, an improvement of interfacial contact with the solid (e.g., lithium metal) electrodes, and a decrease in overall cell resistance. Mixing or combining a solid electrolyte with a solvate and second solvent as described here can reduce or eliminate mechanical instability since the solvate (and second solvent) can fill grain boundaries within the solid electrolyte while maintaining lithium ion conducting channels. In addition, a solvate is more stable against lithium metal electrodes than commercial liquid electrolytes because the solvent molecules are coordinated to the lithium cations, thereby decreasing the likelihood of unwanted side reactions occurring between the solvents and the electrodes.

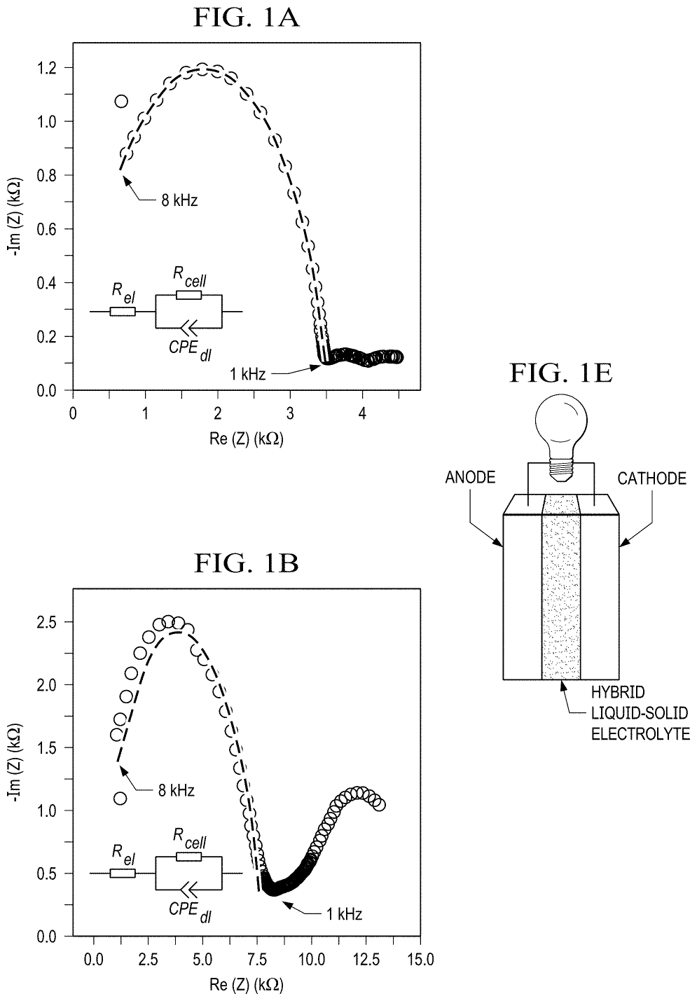

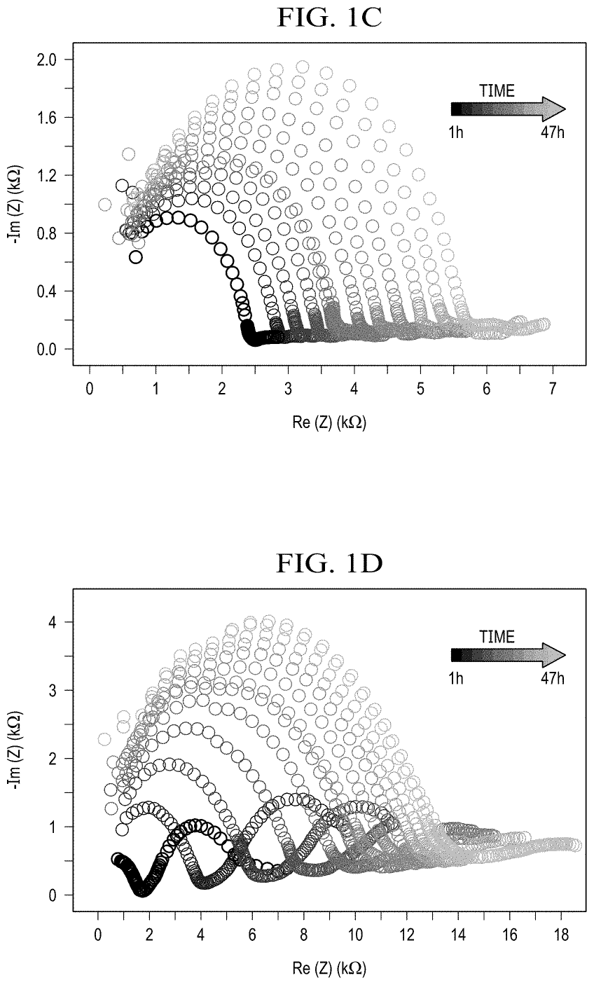

An exemplary battery cell may include a cathode, an anode and the hybrid liquid-solid electrolyte described according to any embodiment in this disclosure disposed between the cathode and the anode, as shown schematically in FIG. 1E. The cathode may comprise a transition metal oxide and/or a sulfur-containing compound. For example, the cathode may include Li₂S. In another example, the cathode may comprise Li₂S and carbon, where the Li₂S typically accounts for from about 20-80 wt. % of the cathode. The anode may comprise carbon (e.g., graphite) or lithium metal. In one example, the anode comprises lithium metal and indium (e.g., a Li—In alloy). In use, the battery cell may exhibit a cell resistance of no greater than about 1.5 kΩ over a time duration of about 48-50 hours, or no greater than about 1 kΩ over that time duration. The battery cell may also exhibit stability over 80 or more cycles, or over 100 or more cycles, as discussed further below in regard to particular examples.

A method of making a hybrid liquid-solid electrolyte is also described in this disclosure. The method may comprise assembling together the following constituents: (a) a solid-phase material comprising a lithium thiophosphate; (b) a solvate comprising a lithium salt and a first solvent; and (c) a second solvent comprising a fluorinated ether, where the second solvent may reduce the viscosity of the solvate. The constituents employed in the method (e.g., the solid-phase material, the solvate, the second solvent) may have any or all of the characteristics set forth above or elsewhere in this disclosure. Typically, the method is carried out in an inert environment at an ambient (room) temperature of 20° C. to 25° C.

In an embodiment in which the solid-phase material comprises a powder, the assembling together may comprise mixing together the above-described constituents. In some cases, prior to the assembly, the powders may be mechanically milled to obtain a reduced particle size.

In an embodiment in which the solid-phase material comprises a porous body having interconnected pores, the assembling together may comprise applying the solvate and the second solvent to a surface of the porous body, such that the solvate and the second solvent penetrate open and interconnected pores. The method may further include, prior to the assembly, forming the porous body by compacting powders comprising the lithium thiosulfate. The compaction may take place at room temperature and at moderate pressures, such as from about 20 MPa to about 40 MPa.

### Example I

In an experimental investigation detailed below, a solvate comprising LiTFSI is mixed with HFE to control viscosity and added to the surface of LPS and LGPS porous bodies (pellets) to form hybrid liquid-solid electrolytes. The overall cell resistance in Li—Li symmetric cells is then evaluated relative to that of their bare Li/SE/Li counterparts. Time-resolved electrochemical impedance spectroscopy (EIS) shows an order of magnitude lower cell resistance for the LGPS-solvate than for the bare LGPS. In contrast, the LPS-solvate system exhibits a higher cell resistance than bare LPS. Scanning electron microscopy (SEM) and electron dispersion X-ray spectroscopy (EDX) show that LGPS allows for the total permeation of the solvate into the bulk SE. While LPS has small grain sizes and higher porosity, it has a higher solubility in TTE which results in a LPS-TTE interlayer on the surface of the pellet, thereby increasing overall cell resistance. Cyclic voltammetry (CV) of the bare and hybrid SE cells shows an order of magnitude higher current density for the LGPS-solvate cell over the bare LGPS. Bare LPS shorts after 2 cycles whereas the LPS-solvate cell does not short within the timeframe of the experiment (100 cycles). This investigation suggests that solvates can be used to improve the cell resistance and current density of solid electrolytes by altering the grain boundary structures and the interphase between electrode and electrolyte.

### Experimental Details

### Electrolyte Preparation

All materials were handled in an Ar environment. Li₁₀GeP₂S₁₂ (LGPS, 99.99%) and Li₇P₃S₁₁ (LPS, 99.99%) were purchased from MSE Supplies LLC. Both solid electrolytes (SEs) were pressed into 12.7 mm diameter pellets by using a hydraulic press. LGPS was pressed into a 1 mm thick pellet at 34.5 MPa and LPS into a 0.75 mm pellet at 28 MPa. The solvate or ‘solvent-in-salt’ was prepared using lithium bis(triflouromethane sulfonyl)imide (LiTFSI, Sigma Aldrich) salt that was dried at 130° C. under vacuum for 8 h. A 7 M LiTFSI in 1:1 (v/v) solution of 1,3-dioxolane (DOL, anhydrous, Sigma-Aldrich) and 1,2-dimethoxyethane (DME, anhydrous, Sigma-Aldrich) was prepared. Dried 1,1,2,2-tetrafluoroethyl 2,2,3,3-tetrafluoropropyl ether (TTE; 99%, Synquest Laboratories) was used to lower the viscosity of the solvate electrolyte. The electrolyte-TTE cosolvent was prepared by diluting the 7 M LiTFSI electrolyte with TTE at 2:1 (v/v, solvate:TTE). All solvents (DOL, DME, and TTE) were dried using activated alumina prior to use.

### Electrochemical Measurements

A two-electrode cell was assembled in a modified Swagelok system using Li foil (Alfa Aesar, 99.9%) for symmetric Li—Li cells. The Li foil (0.75 mm thick) was punched into 8 mm diameter electrodes. Two types of cells were assembled: Li/SE/Li (bare SE cell) and Li/solvate/SE/solvate/Li (SE hybrid cell). The SE hybrid cell was prepared by addition of 50 μL solvate dropwise to the surface of SE pellets. Cyclic voltammogram (CV) measurements were performed using CH Instruments potentiostats. The potential of the working electrode was swept between 0.5 V and −0.5 V vs. Li/Li⁺ at a scan rate of 0.2 mV/s. Scan-rate dependent CV measurements were consecutively taken at scan rates varying from 0.5 mV/s to 0.1 mV/s. Electrochemical impedance spectroscopy (EIS) measurements were performed using a BioLogic Science Instruments impedance analyzer (SP-150) in the range from 1 MHz to 3 mHz with a sinus amplitude of 30 mV.

### Materials Characterization

Scanning Electron Microscopy (SEM) imaging of SE pellet cross-sections was performed using a JEOL JSM-6060LV with an accelerating voltage of 20 kV. Energy-dispersive X-ray spectroscopy (EDX) measurements were acquired using an Oxford Instruments ISIS EDX attached to the SEM. IRXF software was used to perform quantitative analysis on EDX data.

### Powder X-Ray Diffraction (XRD)

Powder XRD measurements were carried out using a Siemens/Bruker D-5000 theta/theta XRD system with a Cu Kα source. Analysis of LPS and LGPS powders were encapsulated under Ar in an air-tight X-ray transparent specimen holder. Jade 9.0 software (Materials Data, Inc.) was used to perform Rietveld refinement.

### Solubility Determination

Solubility of LPS and LGPS in 1:1 (v/v) DOL:DME and TTE was determined by preparing 0.2 M LPS and 0.17 M LGPS solutions using a Thinky planetary mixer. The mixture was gravity filtered using Whatman filter paper (1442-070, 2.5 μm pores) and the remaining SE powders were left to dry in an Ar environment. The SE mass recovered was used to determine the solubility of the SEs in the different solvents.

Porosity of the bare LPS and LGPS pellets was calculated using Equation 1 and Table 1.

$$Porosity ( \% ) = \frac{{ρ}_{theoretical} - {ρ}_{actual}}{{ρ}_{theoretical}} \times 100 \% \qquad ( 1 )$$

TABLE 1
Mass, diameter, thickness, and theoretical density (ρ_{theoretical})
values of LPS and LGPS used to calculate porosity in equation 1.

| | LPS | LGPS |
|---|---|---|
| Mass (g) | 0.19 | 0.16 |
| Diameter (mm) | 8.0 | 8.0 |
| Thickness (mm) | 1.00 | 0.75 |
| ρ_{theoretical} | 1.98 | 2.035 |

TABLE 2
Solubility (g/L) of LPS and LGPS in 1:1 (v/v) DOL:DME
and in TTE.

| SE | Solvent | Solubility (g/L) |
|---|---|---|
| LPS | DOL:DME | 8.280 |
| LPS | TTE | 15.29 |
| LGPS | DOL:DME | 4.047 |
| LGPS | TTE | 7.600 |

### Results and Discussion

### Cell Impedance Analysis

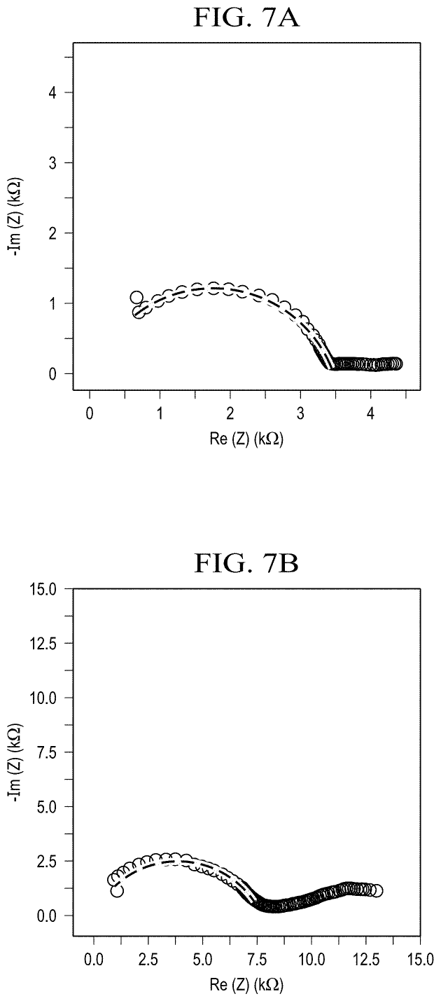

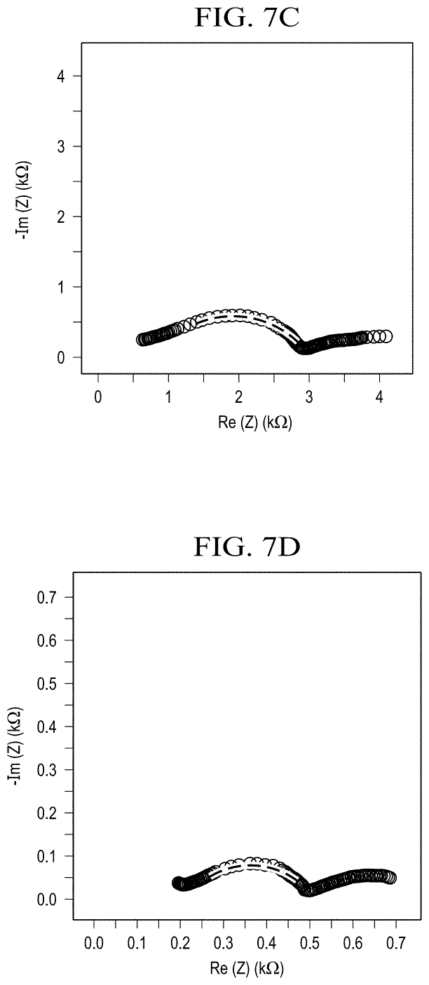

FIGS. 1A-1D show the results of electrochemical impedance spectroscopy (EIS) for both bare LPS (FIGS. 1A and 1C) and LGPS (FIGS. 1B and 1D) in a Li—Li symmetric cell. LGPS exhibits a mid-frequency semicircle which represents the decomposition layer at the interface between the electrode and the electrolyte and a low-frequency, finite-length Warburg impedance. Similarly, LPS exhibits a semicircle in the mid-frequency range. The exemplary Nyquist plots in FIGS. 1A-1B for both the Li/LPS/Li and Li/LGPS/Li cells, respectively, provide a modified Randles circuit, shown as an inset, which was used to extract cell resistance values. The so-called ‘cell resistance’ is likely a combination of resistances from grain boundaries and a decomposition layer. FIGS. 7A-7D highlight the depressing effect of the constant phase element, which is an imperfect capacitor, on the mid-frequency semicircle.

Frequency limits were used to avoid the high-frequency inductance and low-frequency Warburg impedance to determine the cell resistance values obtained from the mid-frequency semicircle. Time-dependence Nyquist plots (FIGS. 1C-1D) from the Li/SE/Li symmetric cells show increasing overall cell resistance for both the LPS and LGPS cells, consistent with prior reports. The low-frequency features are variously described in the literature as a finite-length Warburg impedance and as a parallel resistor-constant phase element semicircle. The variance in results may be attributed to sample preparation (e.g., pellet density), SE particle size and grain boundary effects, EIS parameters (frequency range and duration of experiment), type of cell (e.g., pouch, Swagelok, coin, etc.), and the inherent thermodynamic instability of the thiophosphate SEs against Li electrodes. EIS is therefore considered to be a semi-quantitative technique for SE studies.

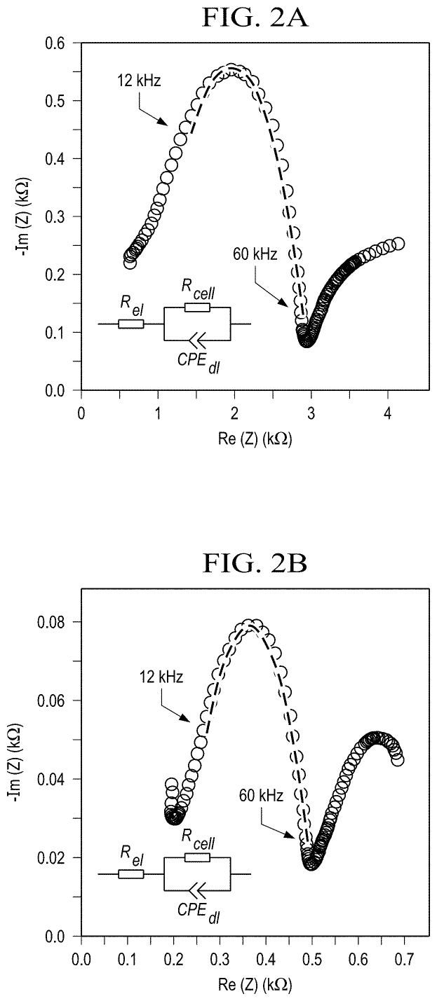

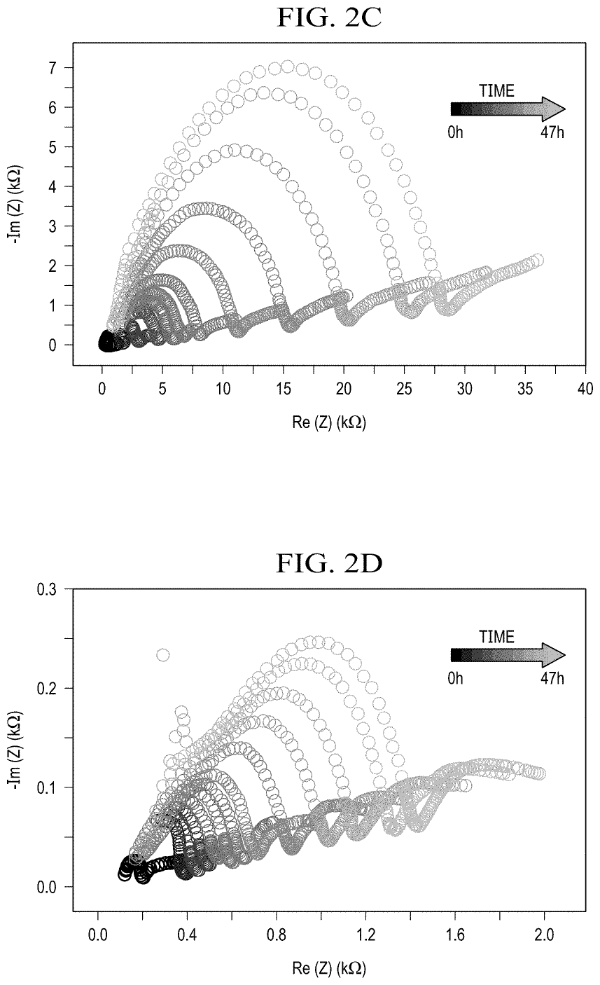

FIGS. 2A-2D show EIS plots obtained from a Li/solvate/LPS/solvate/Li (FIGS. 2A and 2C) and Li/solvate/LGPS/solvate/Li symmetric cells (FIGS. 2B and 2D). The same modified Randles circuit was used to fit the first semicircle for both cells, as shown. As with the Li/SE/Li cells discussed above, these solvate-modified cells exhibit increasing overall cell resistance with time. However, comparison of the cell resistance values from the bare and solvate-modified electrolyte cells show different behavior between LPS and LGPS.

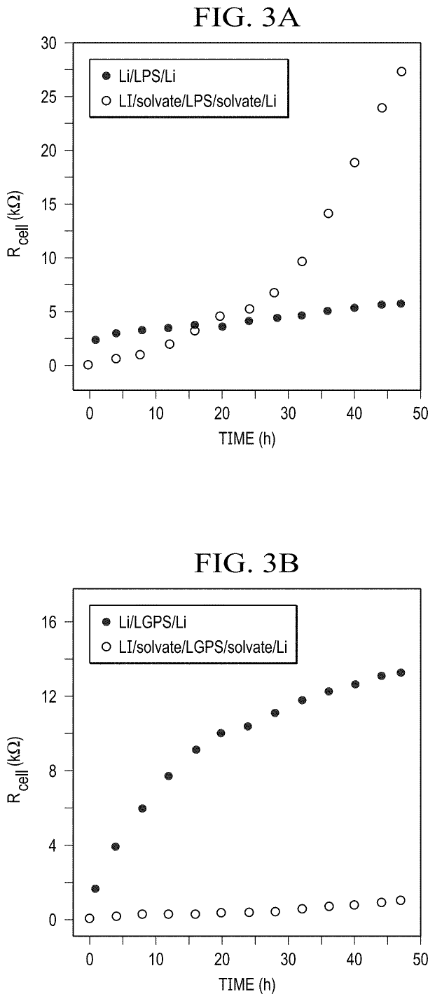

FIGS. 3A-3D shows the cell resistances comparing Li/SE/Li and Li/solvate/SE/solvate/Li for both LPS (FIG. 3A) and LGPS (FIG. 3B). The modified LPS cell shows higher cell resistance values than its bare LPS counterpart starting at 16 h after contacting the Li electrode with the electrolyte. After 47 h, the Li/solvate/LPS/solvate/Li cell exhibited almost five times the cell resistance value of the Li/LPS/Li cell. However, the bare LGPS cell shows over ten times the cell resistance values of the solvate-modified LGPS cell for all time points. This observation shows that a solvate-modified electrolyte is beneficial for LGPS but not LPS. This difference can be attributed to innate morphological differences between LPS and LGPS pellets based on their preparation as described above.

### Cell Morphology

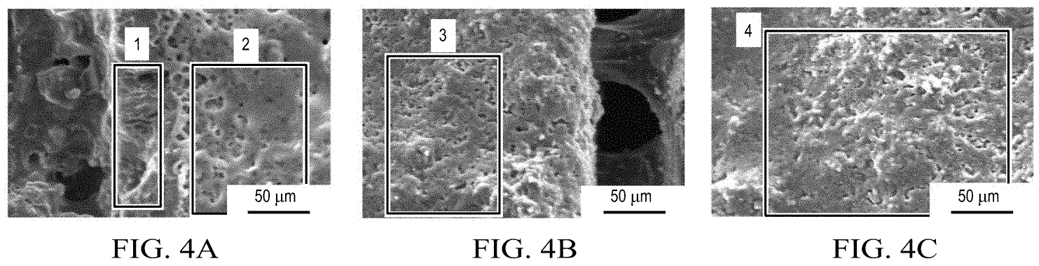

During sample preparation, the solvate formed a thin layer on the surface of the LPS pellet, but no such film was seen on the surface of the LGPS pellet. This is consistent with cross-sectional SEM images of the SE-solvate pellets shown in FIGS. 4A-4C. FIG. 4A shows the cross-section of the LPS-solvate pellet. Closer to the surface of the pellet, there is a different morphology than towards the middle of the cross-section. EDX analysis of these two regions reveals a higher fluorine signal but lower nitrogen, phosphorous, and sulfur signals closer to the surface of the pellet (see Table 3). The lower nitrogen signal indicates that there is less LiTFSI salt in the interlayer than in the middle of the pellet's cross-section since the only source of nitrogen in the LPS-solvate is from the LiTFSI salt (C₂H₆LiNO₄S₂). The sulfur signal appears lower in the interlayer than deeper into the pellet due to the smaller amount of LiTFSI present in the interlayer. Additionally, the lower sulfur and phosphorous signals in the interlayer indicate that there is less LPS in the interlayer than in the bulk of the pellet, as expected. The fluorine signal is higher in the interlayer despite the smaller amount of LiTFSI present. This higher signal is due to the highly fluorinated ether TTE (C₅H₄F₈O) remaining mostly on the surface of the LPS pellet. This phenomenon can be determined using the relative signals within EDX analysis across different areas of the pellet. It is worth noting that EDX compositional analysis cannot be used quantitatively in this study since Li cannot be detected, but it can be used to determine whether solvate has permeated a SE pellet and to what extent.

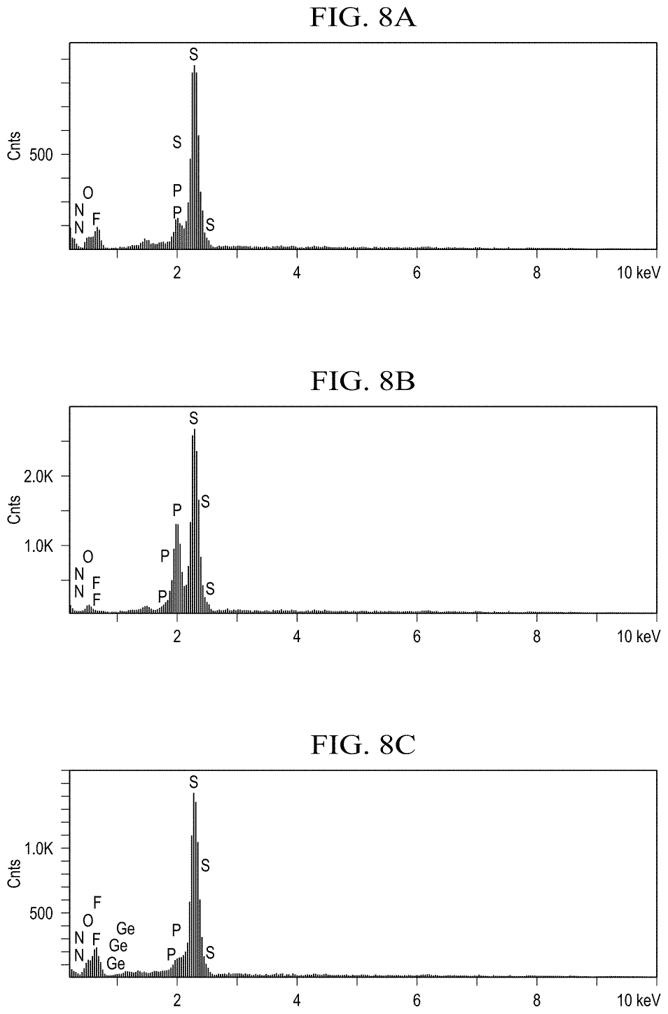

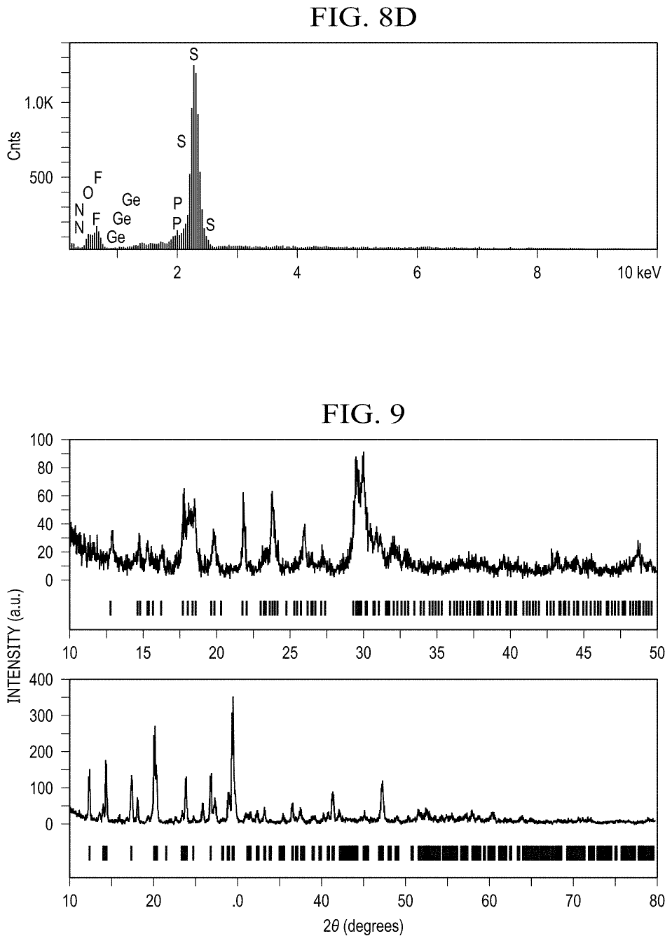

TABLE 3
Cross-sectional EDX compositional analysis for the four regions in
FIGS. 4A-4C for LPS-solvate and LGPS-solvate after 48 h
contact with Li metal electrodes. These values are
based on the EDX spectra in FIG. 8.

| | | | Concentration |
|---|---|---|---|
| EDX Analysis Region | Element Line | Atomic % | (wt %) |
| LPS-solvate region 1 | N Kα | 3.618 | 2.1 |
| (FIG. 4A) | F Kα | 27.669 | 22.2 |
| | P Kα | 4.067 | 5.3 |
| | S Kα | 39.350 | 53.3 |
| LPS-solvate region 2 | N Kα | 14.405 | 7.9 |
| (FIG. 4A) | F Kα | 1.942 | 1.4 |
| | P Kα | 14.416 | 17.4 |
| | S Kα | 48.085 | 60.1 |
| LGPS-solvate region 3 | N Kα | 12.601 | 7.9 |
| (FIG. 4B) | F Kα | 27.993 | 23.8 |
| | p Kα | 2.531 | 3.5 |
| | S Kα | 31.225 | 44.9 |
| | Ge Lα | 0.596 | 1.9 |
| LGPS-solvate region 4 | N Kα | 12.865 | 8.0 |
| (FIG. 4C) | F Kα | 26.606 | 22.6 |
| | p Kα | 2.113 | 2.9 |
| | S Kα | 32.157 | 46.0 |
| | Ge Lα | 0.683 | 2.2 |

The LPS-solvate does not allow for the full permeation of the solvate, and thus part of the solvate acts as an interlayer with an inherent resistance, increasing the overall cell resistance from that of the bare LPS system (FIG. 3A). It has been shown that ionic liquids exhibit decreasing ionic conductivities with increasing viscosities. The use of a solvate, a highly viscous ionic liquid, as an interlayer in the Li/solvate/LPS/solvate/Li cell therefore substantially increases the overall cell resistance.

LGPS-solvate (FIGS. 4B and 4C) shows no morphological differences between cross-sections nearer the surface and farther away. EDX analysis shows the same level of F, N, P, S, and Ge signals throughout the cross-section (Table 3). LGPS allows for the permeation of the solvate, and thus the LGPS-solvate system has a lower overall cell resistance than the bare LGPS system (FIG. 3B) due to the reduction in grain boundaries, the enhanced interfacial contact with Li electrodes, and possibly the reduction in high-resistance degradation byproducts.

To determine the underlying reason for the difference in solvate permeation between the LPS and LGPS systems, powder XRD was conducted on the bare SE powders (FIG. 9) to determine relative grain size. Smaller grains mean more grain boundaries for the solvate to fill. Using whole pattern fitting Rietveld refinement, the grain sizes were determined to be 326 Å for LPS and 1035 Å for LGPS. Despite LPS having smaller grain sizes, and most likely more grain boundaries, The LPS-solvate system's internal resistance is higher than that of the LGPS-solvate.

Another possibility for the difference in solvate permeation between the two SE systems is the relative porosity of the SE pellets. Porosity was calculated using the theoretically calculated SE densities and the actual densities of the pellets used in this study (Eqn. 1). The theoretical density values were obtained from the literature, and the actual densities were determined using the pellet mass, area, and thickness (Table 1). The porosity is calculated to be 24.2% for bare LPS and 12.7% for bare LGPS. The smaller porosity of the LGPS pellet does not explain why this system has better solvate permeation than the LPS pellet.

Solubility of LPS and LGPS in 1:1 (v/v) DOL:DME and in TTE revealed higher solubility of LPS in both solvent systems (Table 2). The TTE on the surface of the LPS pellet may form a layer of LPS dissolved in TTE. Despite the smaller grain size of LPS, the higher calculated porosity, and the higher solubility in DOL/DME and TTE solvents, LPS has a lower permeability for the solvate than LGPS. The lower intermolecular interactions of LGPS with the solvate allow the solvate to more freely move throughout the pellet's pores. The porosity calculated in equation 1 indicates the overall pore volume within a pellet. However, if the pore channels are smaller and do not have an extensive 3-D network, then the solvate is less likely to fully permeate. Therefore, despite the lower calculated porosity for LGPS, its interconnected 3-dimensional network of pores throughout the cross-section (FIGS. 4B and 4C) allow for the full permeation of solvate, unlike the LPS system.

### Cyclic Voltammetry

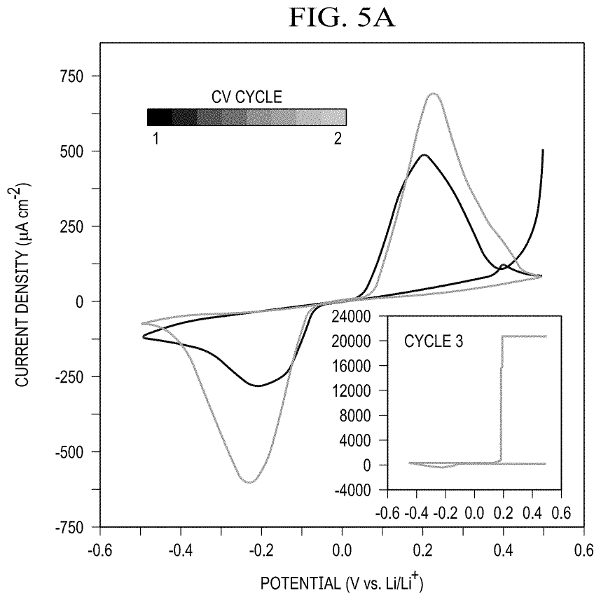

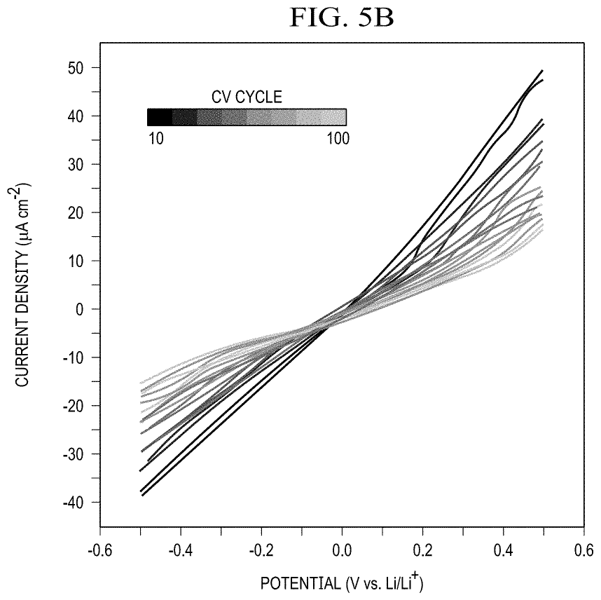

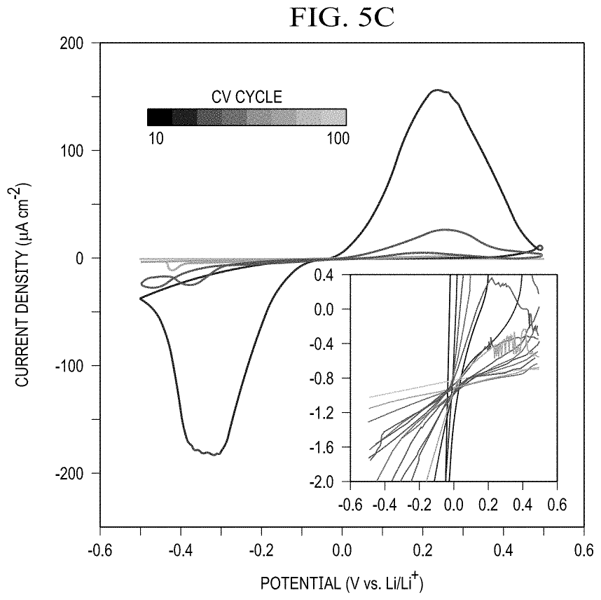

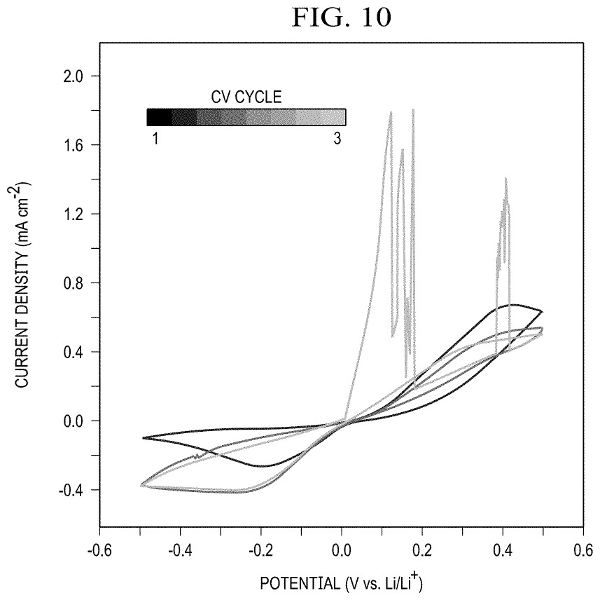

FIGS. 5A-5D show CV plots for the bare SE and hybrid SE Li—Li symmetric cells. The Li/LPS/Li cell (FIG. 5A) completes two cycles before shorting. This behavior is attributed to the mechanical instability of LPS. Any imperfections or microcracks in the LPS pellet propagate during the first two cycles and allow Li dendrite growth, leading to an eventual short circuit (FIG. 5A inset). Upon addition of solvate (FIG. 5C), the Li/solvate/LPS/solvate/Li cell does not short in the timeframe of the experiment (i.e., 100 cycles). The CV plot for this cell appears noisy (FIG. 5C inset) possibly due to the formation of dendrites. The SE is beneficial in hybrid cells because a Li—Li symmetric cell with just the solvate and a glass fiber separator (i.e., no SE) forms dendrites after two cycles (FIG. 10) and eventually shorts. Thus, the SE is a more effective separator for the solvate than a glass fiber separator and may be necessary for long term cycling.

Unlike the bare LPS cell, the Li/LGPS/Li cell (FIG. 5B) does not short within 100 cycles. Its current density decreases with increasing cycle number. The Li/solvate/LGPS/solvate/Li cell (FIG. 5D) shows an increase in current density for the first forty cycles followed by a gradual decrease in current density. This initial increase may be attributed to the solvate stabilizing the LGPS pellet mechanically and the better interfacial contact between the electrodes and electrolyte. The hybrid LGPS cell has a current density almost ten times higher than its bare counterpart which can be attributed to the reduction in grain boundaries in the hybrid cell. However, the peaks in the hybrid cell CV suggest that there is a depletion layer which is not observed for the bare cell.

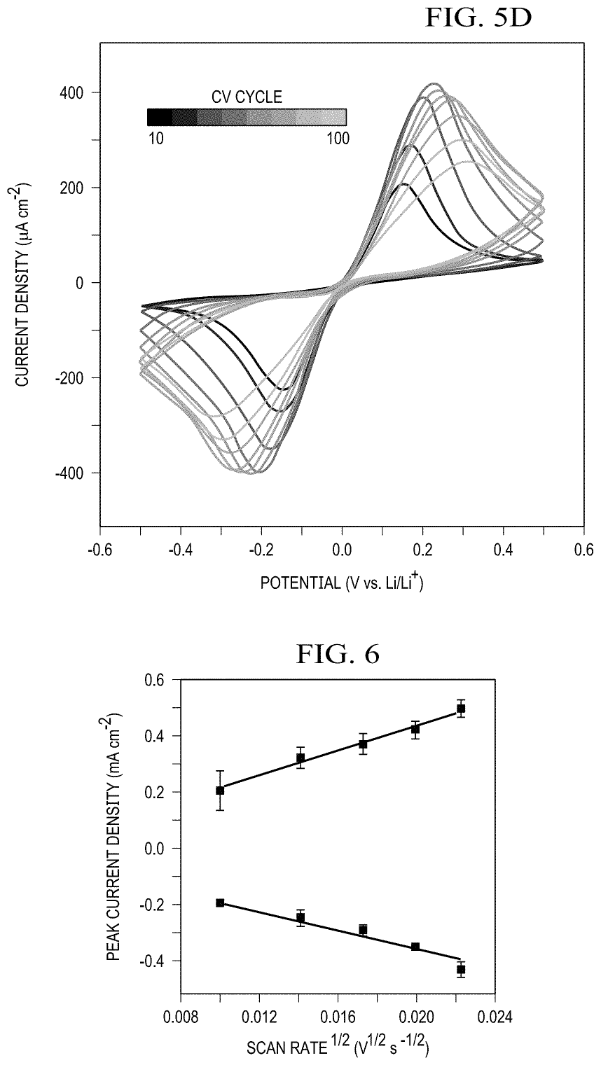

FIG. 6 shows the peak current density dependence on the square root of the scan rate for the Li/solvate/LGPS/solvate/Li cell. The Randles-S̆evćik equation (1) is often used to demonstrate electrochemical reversibility, where iₚ is the peak current, n is the number of electrons transferred in the electrochemical reaction, A is the active area of the electrode, D_{O} is the diffusion coefficient of the oxidized species, C_{O} is the concentration of the oxidized species, and v is the scan rate. This equation indicates that the system is under diffusion control if iₚ is proportional to v^{1/2}, as is demonstrated in FIG. 6. The low Li-ion mobility within the viscous solvate results in the formation of a depletion layer at the interface between the electrode and electrolyte, leading to a diffusion-limited electron transfer. The same scan rate study was applied to the LPS-solvate symmetric cell, but peak current density values could not be extracted due to the high level of noise in the CV plots as previously mentioned.

$${i}_{p} = ( 2.69 \times {10}^{5} ) {n}^{\frac{3}{2}} {AD}_{O}^{\frac{1}{2}} {C}_{O} {c}^{\frac{1}{2}} \qquad ( 1 )$$

In summary, in this investigation, hybrid liquid-solid electrolytes comprising thiophosphate solid electrolytes and LiTFSI solvate were used in Li—Li symmetric cells to show the decreased cell resistance of the LGPS-solvate cell relative to the bare LGPS cell when the SE is placed in contact with Li metal electrodes for 48 h. Despite its overall lower porosity, larger grain size, and lower solubility in DOL/DME and TTE, LGPS allows the solvate to permeate more than LPS due to its highly interconnected network of larger pores throughout the SE pellet. These larger pores allow for the full permeation of the solvate into the pellet as can be seen by the relatively constant EDX elemental composition throughout the cross-section of the SE pellet. The varying elemental composition within the LPS-solvate system indicates that the solvate does not permeate evenly throughout the pellet. The thin layer that forms on the surface of the LPS pellet leads to higher cell resistance compared to the bare LPS cell. Cyclic voltammetry revealed the ability of the Li/solvate/LPS/solvate/Li cell to undergo 100 cycles, possibly due to increased mechanical stability, whereas the bare LPS cell shorts after 2 circuits. The LGPS-solvate cell is shown to have current densities an order of magnitude higher than those of its bare counterpart. However, the improved cell resistivity and current density is at the cost of forming a depletion layer at the interface of the hybrid LGPS system. This strategy of adding a solvate to a solid electrolyte can potentially be used with other types of SEs to reduce overall cell resistance and improve ionic conductivity.

### Example II

In another experimental investigation, a hybrid Li₂S battery is prepared using a hybrid liquid-solid electrolyte and its electrochemical performance is evaluated. In this example, the lithium triophosphate takes the form of a particulate material which is mixed with the solvate and the second solvent. The hybrid liquid-solid electrolyte thus has a paste-like, spreadable morphology and can be spread onto a coin cell for electrochemical measurements.

### Material Preparation

Reagent-grade Li₂S (99.98%) was purchased from Sigma Aldrich. Li₇P₃S₁₁ (LPS; 99.99%, MSE Supplies LLC) was used as received. A composite cathode is formed from Li₂S, carbon black (Ketjenblack), and LPS. Li₂S was prepared by ball-milling the as received Li₂S at 370 rpm for 20 h to decrease the particle size and the crystallite size. The material was placed in an agate mill jar (50 mL) with agate balls (3 mm and 5 mm) and sealed in an Ar-filled glovebox. Ball-milling was performed using a high energy planetary ball-mill apparatus (MSE Supplies LLC, MSE-PMV1-0.4L). The Li₂S/C composite cathode was prepared by mixing the ball-milled Li₂S and Ketjenblack (EC-600JD, AkzoNobel) at a 1:1 weight ratio at 370 rpm for 10 h in the ball-mill. The solvate electrolyte, (MeCN)₂-LiTFSI, and its diluent were prepared as known in the art. A stoichiometric ratio of 2 mol MeCN (99.8%, Sigma Aldrich) and 1 mol LiTFSI (99.95%, Sigma Aldrich) were stirred overnight to yield a clear, viscous solution. The cosolvent, 1,1,2,2-tetrafluoroethyl 2,2,3,3-tetrafluoropropyl ether (TTE; 99%, Synquest Laboratories), was used to decrease the viscosity of the (MeCN)₂-LiTFSI solvate. The electrolyte with TTE added, denoted as (MeCN)₂-LiTFSI:TTE, was prepared by diluting (MeCN)₂-LiTFSI with TTE at volume ratio of 2:1. The water content of MeCN and TTE was measured by Karl Fisher titration (Photovolt Aquatest Karl-Fischer Coulometric Titrator) and was less than 5 ppm.

### Hybrid Li₂S Cell Assembly

The hybrid Li₂S cell is assembled in a CR2032 coin cell (MTI Corporation) and includes the hybrid liquid-solid electrolyte, Li—In anode, and Li₂S/C composite cathode. The electrolyte is prepared by mixing 40 wt. % of (MeCN)₂-LiTFSI:TTE solvate with 60 wt. % of LPS using mortar and pestle, where MeCN refers to acetonitrile. The (MeCN)₂-LiTFSI:TTE solvate has a slightly higher conductivity than that of LPS. The coin cell is assembled by first placing the Li—In anode on the stainless-steel disk (15.5 mm diameter). Then the electrolyte (300 mg) is spread onto the Li—In anode, followed by spreading of the Li₂S/C composite (5-6 mg), resulting in a Li₂S loading of 1.32-1.58 mg cm⁻². The cell is closed with a hydraulic crimping machine (MTI Corporation).

### Electrochemical Performance

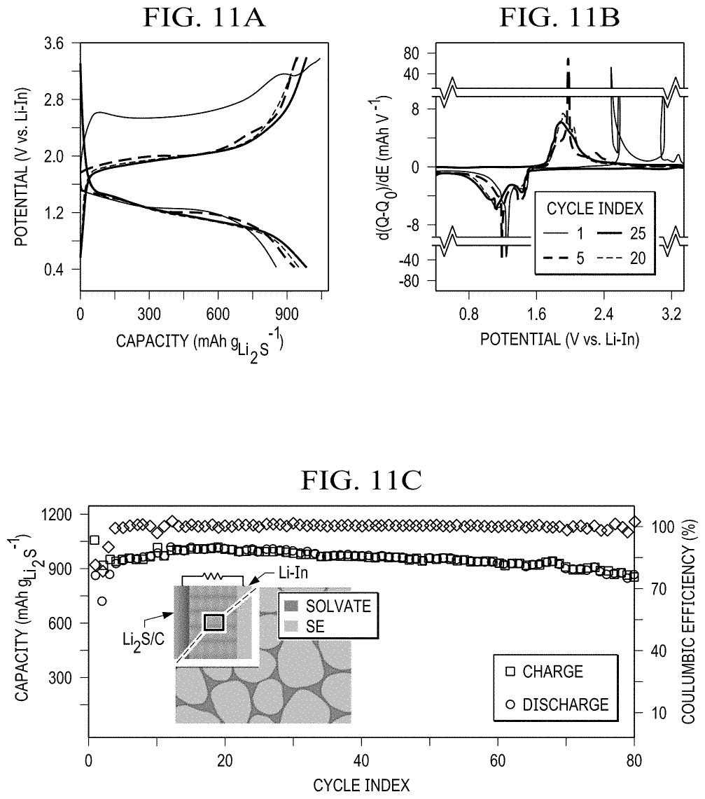

FIG. 11A shows the charge and discharge profile of the solid-liquid hybrid cell and FIG. 11B shows the corresponding differential capacity plot. FIG. 11C shows the cycling performance of the hybrid Li₂S cell using the hybrid liquid-solid electrolyte. The cell is cycled between 0.38 V and 3.38 V vs. Li—In (1 V and 4 V vs. Li/Li*) at a current loading of C/10. Electrochemical measurement is performed at room temperature. The inset to FIG. 11C shows the schematic representation of the hybrid cell and the hybrid liquid-solid electrolyte. A slight increase in capacity is observed for the first 11 cycles reaching a discharge capacity of 1030 mAh u_{Li}_{₂}_{S}⁻¹ (1480 mAh g_{S}_{₈}⁻¹) at cycle 12, corresponding to 88% active material utilization. A slight decrease in capacity is observed upon extended cycling, but the hybrid cell still exhibits a good cyclability delivering 880 mAh g_{Li}_{₂}_{S}⁻¹ (1264 mAh g_{S}_{₈}⁻¹) at cycle 80. Generally speaking, the discharge capacity of a hybrid Li₂S cell fabricated as described in this disclosure may be expected to be at least 860 mAh g_{Li}_{₂}_{S}⁻¹ (or at least 1230 mAh g_{S}_{₈}⁻¹) at cycle 80. This exceptional cycling performance may be attributed to favorable ionic contact at the battery interfaces.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A hybrid liquid-solid electrolyte for a lithium metal battery, the hybrid liquid-solid electrolyte comprising:
a solid-phase material comprising a lithium thiophosphate;
a solvate comprising a lithium salt and a first solvent; and
a second solvent to reduce viscosity of the solvate, the second solvent comprising a fluorinated ether.

2. The hybrid liquid-solid electrolyte of claim 1, wherein the solid-phase material comprises a powder or a porous body.

3. The hybrid liquid-solid electrolyte of claim 2, wherein the porous body has interconnected pores penetrated by the solvate and the second solvent.

4. The hybrid liquid-solid electrolyte of claim 2, wherein the powder is mixed with the solvate and the second solvent.

5. The hybrid liquid-solid electrolyte of claim 1, wherein the lithium thiophosphate consists essentially of lithium, phosphorus and sulfur.

6. The hybrid liquid-solid electrolyte of claim 1, wherein the lithium thiophosphate further comprises an element selected from the group consisting of germanium, aluminum, tin, chlorine, bromine, boron, and silicon.

7. The hybrid liquid-solid electrolyte of claim 1, wherein the solvate includes the lithium salt at a molar concentration in a range from about 1-5 mol/L.

8. The hybrid liquid-solid electrolyte of claim 1, wherein the lithium salt is selected from the group consisting of: lithium bis(trifluoromethane sulfonyl)imide (LiTFSI), lithium tetrafluoroborate (LiBF₄) and lithium bis(fluorosulfonyl)imide (LiFSI), and lithium hexafluorophosphate (LiPF₆).

9. The hybrid liquid-solid electrolyte of claim 1, wherein the first solvent is selected from the group consisting of: 1,3-dioxolane (DOL), 1,2-dimethoxyethane (DME), ethylene carbonate, dimethyl carbonate, tetrahydrofuran, acetonitrile, triethylene glycol dimethyl ether, and water.

10. The hybrid liquid-solid electrolyte of claim 1, wherein the fluorinated ether is a highly fluorinated ether (HFE), the HFE being at least about 90% fluorinated.

11. The hybrid liquid-solid electrolyte of claim 1, wherein the fluorinated ether comprises 1,1,2,2,-tetrafluoroethyl 2,2,3,3-tetrafluoropropyl ether.

12. A battery cell comprising:
a cathode;
an anode; and
the hybrid liquid-solid electrolyte of claim 1 sandwiched between the cathode and the anode.

13. The battery cell of claim 12, wherein the cathode comprises a transition metal oxide or a sulfur-containing compound, and
wherein the anode comprises lithium metal or carbon.

14. The battery cell of claim 12 exhibiting a cell resistance of no greater than about 1.5 kΩ over a time duration of about 48-50 hours.

15. The battery cell of claim 12 exhibiting stability over 100 or more cycles.

16. A method of making a hybrid liquid-solid electrolyte, the method comprising:
assembling together: (a) a solid-phase material comprising a lithium thiophosphate; (b) a solvate comprising a lithium salt and a first solvent; and (c) second solvent for reducing a viscosity of the solvate, the second solvent comprising a fluorinated ether.

17. The method of claim 16, wherein the solid-phase material comprises a powder, and wherein the assembling together comprises mixing.

18. The method of claim 17, further comprising, prior to the assembly, mechanically milling the powder to obtain a reduced particle size.

19. The method of claim 16, wherein the solid-phase material comprises a porous body having interconnected pores, and wherein the assembling together comprises applying a mixture comprising the solvate and the second solvent to a surface of the porous body, the mixture penetrating the interconnected pores.

20. The method of claim 19, further comprising, prior to the assembly, forming the porous body by compacting powders comprising the lithium thiosulfate.
